(19) United States
(12) Patent Application Publication
(10) Pub. No.: US 2025/0182377 A1
(43) Pub. Date: Jun. 5, 2025

(54) CONFIGURABLE RAY/EDGE TESTING FOR CONVEX POLYGON GROUPS

(71) Applicant: Advanced Micro Devices, Inc., Santa Clara, CA (US)

(72) Inventor: Andrew Erin Kensler, Bellevue, WA (US)

(73) Assignee: Advanced Micro Devices, Inc., Santa Clara, CA (US)

(21) Appl. No.: 18/527,144

(22) Filed: Dec. 1, 2023

(51) Int. Cl. G06T 15/06

(52) U.S. Cl. CPC G06T 15/06

(57) ABSTRACT

A technique for performing inside/outside testing is provided. To determine if a ray intersects a convex polygon, an inside/outside test is commonly performed by checking which side of an edge the ray passes. By efficiently sharing edge test results among polygons with shared edges, inside/outside testing for groups of polygons can be made more efficient. This optimization can be achieved using either full precision floating-point math or reduced precision (e.g., fixed-point math) to make hardware-based testing more cost-effective.

### BACKGROUND

Ray tracing is a rendering technique used in computer graphics to generate realistic images by simulating the behavior of light in a virtual 3D environment. It works by tracing the path of light rays as they interact with objects in the scene, ultimately determining the color and illumination of each pixel in the final image.

When evaluating whether a ray intersects with a convex polygon (e.g., a triangle), the first step of the intersection test involves checking whether the ray is on the inside or outside of the polygon. This is determined by analyzing the ray's orientation in relation to each of the polygon's edges to determine which side it lies on. However, when dealing with collections of convex polygons, like triangle meshes, quad meshes, triangle strips, triangle fans, and convex polyhedra, independently testing the ray against the edges of each polygon can lead to redundant computations, especially when polygons share common edges.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5A is an illustration of an example mesh, according to an example;

FIG. 5B is an illustration of triangles that comprise a smaller mesh, according to an example;

FIG. 5C is an illustration of edges that comprise a smaller mesh, according to an example

FIG. 5D is an illustration of an example inside/outside testing for a particular example triangle of the smaller mesh using a counter-clockwise (CCW) orientation;

FIG. 5E is an illustration of an example inside/outside testing for a particular example triangle of the smaller mesh using a clockwise (CW) orientation;

FIG. 5F is an illustration of an example inside/outside testing for a particular example triangle of the smaller mesh;

FIG. 5G is an illustration of an example inside/outside testing for a particular example triangle of the smaller mesh;

FIG. 5H is an illustration of an example inside/outside testing for a particular example triangle of the smaller mesh; and

FIG. 6 is a flow diagram of a method for inside/outside testing, according to an example.

### DETAILED DESCRIPTION

The process of detecting if a ray intersects with a convex polygon usually includes an inside/outside test. This test involves determining which side of an edge the ray passes by. To enhance the efficiency of inside/outside testing for groups of polygons, the results of common edge tests can be shared among polygons that have shared edges in a configurable manner. This sharing of test results optimizes the overall performance of ray-polygon intersection checks for polygon collections.

The process of ray tracing involves casting rays from the virtual camera through each pixel of the image plane and into the scene. These rays simulate the path of light as it travels from the camera's viewpoint into the scene, bouncing off objects and interacting with various surfaces. The rays are traced until they either hit a light source, resulting in direct illumination, or they reach a specified maximum number of bounces, determining the level of indirect illumination.

Plane testing is the process of determining whether a ray intersects with a plane in the 3D scene being rendered. Plane testing plays a crucial role in ray tracing by determining which planes are intersected by the traced rays, enabling the calculation of accurate lighting, reflections, and other visual effects in the rendered scene. This test is an essential part of the ray tracing algorithm, as it helps determine which objects or surfaces in the scene are intersected by the rays.

To perform plane testing, the algorithm needs to define the properties of the plane and the ray being traced. A plane is typically represented by a normal vector and a point on the plane. The normal vector describes the orientation or direction of the plane, and the point defines a location on the plane.

The ray, on the other hand, is defined by its origin (starting point) and its direction vector (indicating the direction of the ray). The goal of plane testing is to determine if and where the ray intersects the plane.

One common approach to implement plane testing is to use the equation of a plane, which states that a point (x, y, z) lies on the plane if it satisfies the equation: Ax+By+Cz+D=0 where A, B, C, and D are the coefficients defining the plane. By substituting the coordinates of a point on the ray into this equation, the algorithm can determine if the ray intersects the plane.

If the ray intersects the plane, the algorithm can calculate the point of intersection by finding the parameter t at which the ray equation and the plane equation are satisfied simultaneously. The intersection point can then be used for further calculations, such as determining the color or properties of the surface at that point.

Inside/outside testing is the process of determining whether a point in 3D space is inside or outside of a geometric shape or volume. This testing is essential for various operations in ray tracing, such as determining visibility, determining if a ray hits an object, or performing surface shading calculations.

Inside/outside testing is typically performed using geometric representations of objects, such as triangles, spheres, or other complex shapes. The goal is to determine if a given point lies within the defined boundaries of the shape.

For example, in the case of a triangle, given a point P in 3D space, the Inside/outside algorithm can determine if it is inside or outside the triangle by performing a set of tests. One common method is to check if the point is on the same side of each triangle edge consistently. If it is, then the point is inside the triangle; otherwise, it is outside. Specifically, the same side test follows each edge in accordance with its directionality and gives the notion of the edges having particular “sides” (e.g., a left side and right side). If the point is to the right of all edges with clockwise (CW) winding or to the left of all edges with counter clockwise (CCW) winding, then the point is in the triangle, otherwise the point is not within the triangle.

In some instances, to perform this test, the inside/outside algorithm calculates the barycentric coordinates of the point P with respect to the triangle. Barycentric coordinates express a point in terms of weights relative to the vertices of a triangle. By determining these coordinates, the inside/outside algorithm can check if they fall within the range [0,1] for all edges of the triangle. If they do, then the point is inside the triangle.

Inside/outside testing can also be performed for more complex shapes like spheres, boxes, or other geometric primitives. Each shape has its own specific tests based on its mathematical representation.

In ray tracing, inside/outside testing is used for various purposes. For example, when tracing a ray from the camera into the scene, the ray may need to pass through multiple objects. Inside/outside testing helps determine which objects the ray intersects, allowing for accurate calculations of reflections, refractions, and shadows.

Additionally, inside/outside testing is crucial for determining visibility. When testing for visibility between two points in the scene, such as when checking if a light source is visible from a surface, inside/outside testing is employed to ensure that no objects obstruct the line of sight between the points.

Two-dimensional inside/outside testing is a technique used to determine whether a point lies inside or outside a two-dimensional shape, such as a polygon or a circle. It involves evaluating the position of the point relative to the shape's boundaries using geometric calculations.

Generally, 2D inside/outside testing algorithms project 3D hit points and vertices to a plane. The algorithm, when testing whether a point lies inside a triangle, then compares the hit point against three half-spaces defined by each of the three triangle edges. A point is within the perimeter of all half-spaces or outside all half-spaces. The edge direction determines whether the point is inside or outside. In many cases, the algorithms are used to simplify computation by reducing the dimensionality. For instance, in 2D inside/outside testing, if the projected point is inside the projected triangle, then the corresponding 3D point must be inside the 3D triangle.

Edge direction refers to the direction or orientation of the edges of a polygon or a triangle. It provides information about how the vertices of the polygon are connected to form the edges. Each edge of a polygon is defined by two adjacent vertices. The edge direction describes the relative position and orientation of these vertices. It can be represented as a vector or a normalized direction vector pointing from one vertex to the next.

An example algorithm for inside/outside testing in a two-dimensional context is the Point-Polygon Test. The Point-in-Polygon Test is used to determine if a point lies inside a polygon. The polygon is defined by a set of vertices, and the test involves counting the number of times a ray originating from the point intersects the edges of the polygon.

The algorithm for the point-in-polygon test includes (1) casting a horizontal ray from the point to the right (or left); (2) counting the number of intersections between the ray and the polygon's edges; and (3) if the count is odd, the point is inside the polygon; if it's even, the point is outside.

Point-in-Polygon works because, in a simple, non-self-intersecting polygon, the ray will intersect an odd number of edges if the point is inside the polygon and an even number if the point is outside.

Three-dimensional Inside/Outside Testing determines whether a point lies inside or outside a three-dimensional object or volume. It involves evaluating the position of the point relative to the boundaries of the object using geometric calculations.

Three-dimensional Inside/Outside Testing in ray tracing involves evaluating the position of a point relative to the boundaries of objects or volumes in the scene. Solid geometry testing, Signed Distance Functions (SDF)-based methods, and BVH traversal are commonly used approaches to determine the inside/outside relationship, enabling accurate rendering and interactions with the 3D environment.

Solid geometry testing involves representing objects or volumes as closed surfaces, such as meshes composed of polygons. To determine if a point is inside or outside an object, the algorithm can perform a point-in-polygon test for each polygon or face that forms the surface of the object. If the point is inside an odd number of polygons, it is considered inside the object; otherwise, it is outside.

An alternative approach is to use Signed Distance Functions (SDFs) to represent objects or volumes. An SDF defines the signed distance from any point in space to the nearest surface of the object. By evaluating the SDF at a given point, the algorithm can determine if it is inside (negative distance) or outside (positive distance) the object. SDF-based techniques, such as voxel grids or distance fields, provide efficient and accurate Inside/Outside Testing for complex and detailed objects.

Bounding Volume Hierarchies (BVH) and Binary Space Partitioning (BSP) are two techniques often used in computer graphics, computational geometry, and game development for tasks like collision detection, rendering, and other spatial queries. Both techniques aim to optimize operations by reducing the number of objects or elements that need to be considered for a given calculation

Binary Space Partitioning (BSP) is a spatial partitioning technique that hierarchically organizes objects or volumes into bounding volumes, such as axis-aligned bounding boxes (AABBs) or bounding spheres. This volume is then recursively subdivided into smaller bounding volumes until a certain termination condition is met. At each level of the hierarchy, the bounding volume is split into child bounding volumes, and this process continues until a specific criterion is reached. Leaf nodes in the BSP are the terminal nodes of this hierarchy, and they contain actual objects or geometry of the scene. In other words, leaf nodes represent individual triangles, meshes, or other primitive shapes that make up the 3D objects in the scene. These leaf nodes provide a compact representation of the geometry distribution within the volume and allow for efficient intersection tests during tasks like ray tracing, collision detection, or rendering.

Bounding Volume Hierarchies (BVHs) are an object partitioning technique, where the objects themselves are recursively partitioned into smaller and smaller groups. The BVH is constructed by iteratively dividing the set of objects and encasing them in bounding volumes, creating a binary tree-like hierarchy in the process. Starting with all objects in the root, a typical approach for the subdivision involves choosing a partitioning axis (often the axis along which the objects have the most spread) and dividing the objects based on their median position along that axis. Two or more child nodes are then created, each holding a bounding volume that encloses a subset of the objects. This process continues recursively until a termination condition is met, often when a bounding volume contains fewer than a predetermined number of objects. Like in the case of BSP, these terminal nodes are referred to as leaf nodes. Subtrees within a BVH can overlap spatially, but they will normally be disjoint in terms of the subset of objects (with a few special-case exceptions such as “box splitting”).

A mesh is a three-dimensional object or surface representation composed of interconnected polygons. A mesh consists of vertices, edges, and faces. Vertices are the points in 3D space that define the shape of the object. Edges connect pairs of vertices, forming lines, and faces are polygons formed by connecting three or more vertices through edges.

The most common type of mesh used in ray tracing is the triangle mesh, where each face of the mesh is a triangle. Triangles are particularly useful because they are planar and can be efficiently processed for intersection tests with rays.

Meshes in ray tracing are often organized using spatial data structures like BVHs or octrees. These acceleration structures improve the efficiency of intersection tests by reducing the number of triangles that need to be checked, optimizing the rendering performance.

Watertightness is a property of a 3D geometric model or mesh, indicating whether it forms a closed and continuous surface with no gaps, holes, or self-intersections. A watertight model is one in which the geometry is completely enclosed, resembling a solid volume that contains no leaks.

Watertightness is crucial in various computer graphics applications, including rendering, 3D printing, virtual reality, and physics-based simulations. Watertight models provide a well-defined surface representation that allows for accurate calculations of lighting, shadows, reflections, and other visual effects. Additionally, water tightness is often a requirement for 3D printing to ensure that the physical object is properly formed and free from defects.

Winding order, also known as vertex order or face orientation, refers to the order in which the vertices of a polygon or face are specified or arranged. It determines whether the face is considered front-facing or back-facing with respect to the viewer or the direction of the ray being traced.

The winding order convention is typically used to determine which polygons are visible and which are hidden when rendering a 3D scene. The convention establishes a consistent rule for determining whether a ray intersects the front or back face of a polygon, helping to determine visibility and perform accurate shading calculations.

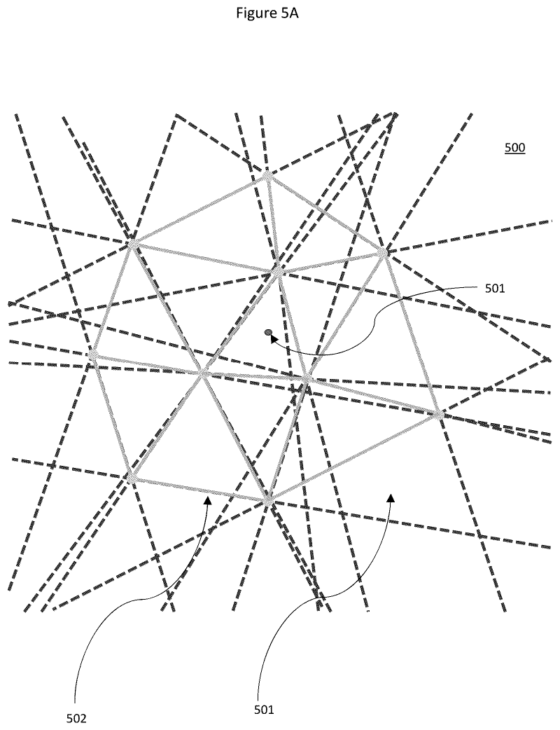

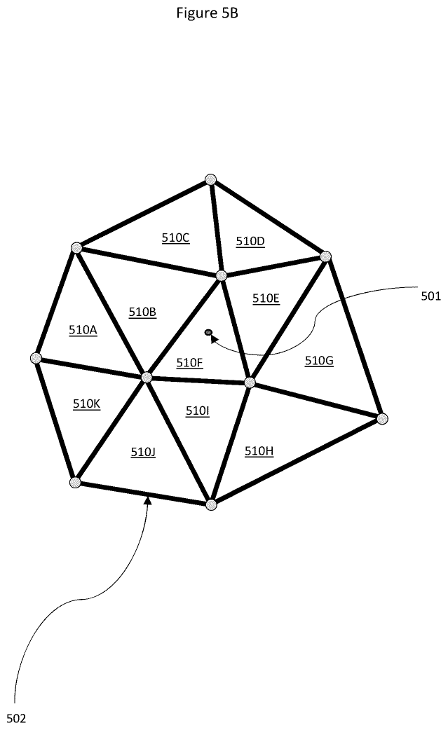

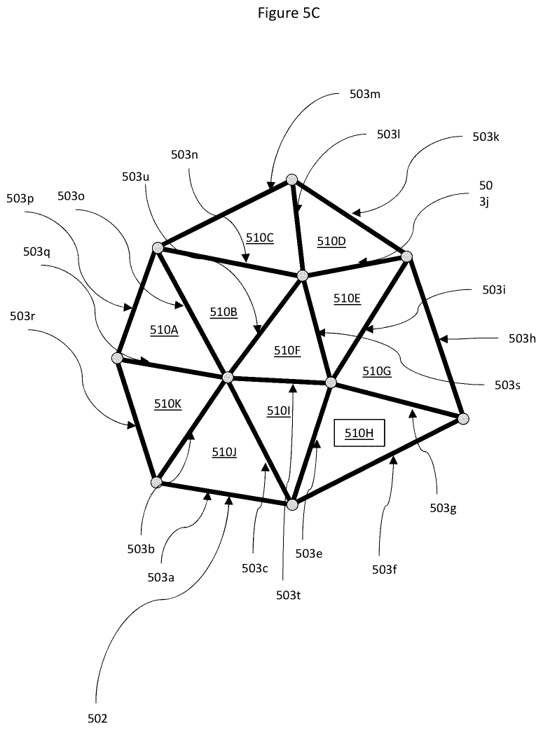

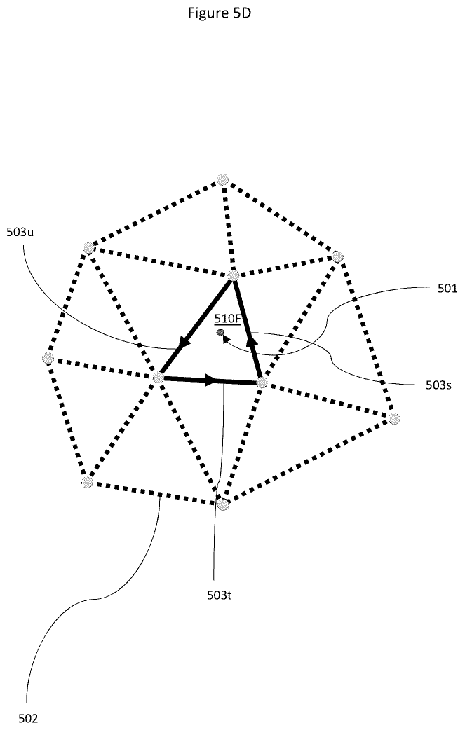

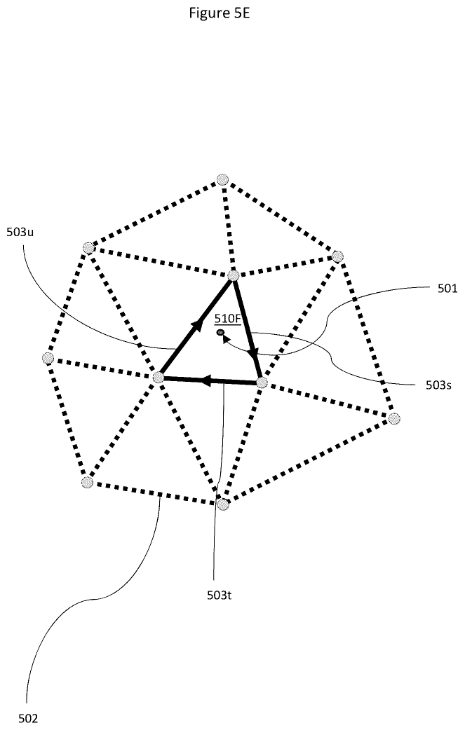

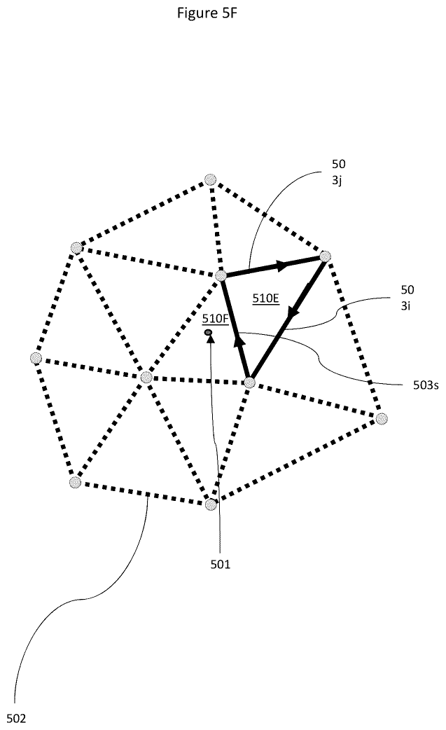

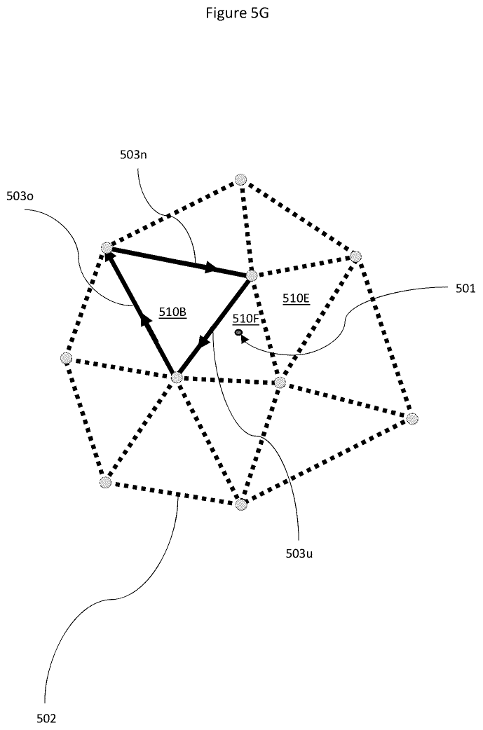

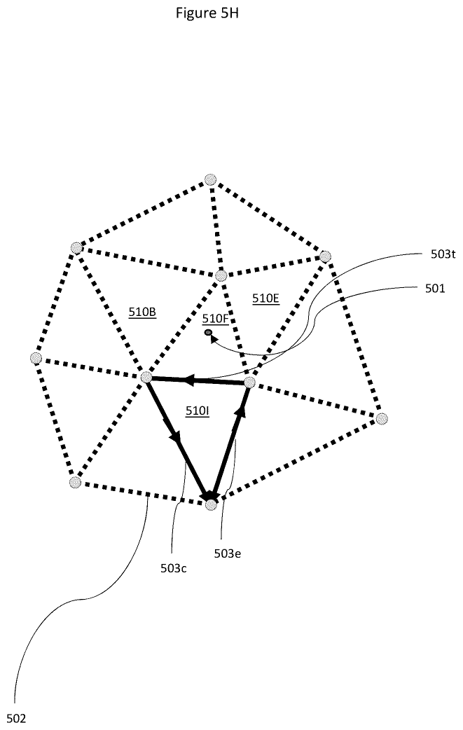

In a shape where adjacent polygons abut (such as in a mesh), the winding order must be maintained. For example, if triangle A, with a counter-clockwise winding order, shares a common edge with triangle B, triangle B will have a clockwise winding order. (See, for example, triangles 510F and 510E of FIGS. 5D and 5E). In some instances, the winding order may be configured to maintain consistency with the front and back of the object in 3D space.

Typically, the winding order is carefully tracked and taken into account when computing “face normals.” “Face normals” are vectors that are perpendicular to the surface of a polygon or a face of a 3D geometric object. They are often used to define the orientation and shading of the object's surface, as well as to determine how it interacts with lighting and other visual effects. Since every polygon has a front side and a back side, and the direction of the face normal determines which side is considered the front, the accuracy and consistency of “face normals” are essential for achieving realistic lighting and shading effects in computer graphics. “Face normals” are typically calculated based on the vertices of a polygon using cross-product calculations, ensuring that they point outward from the visible side of the polygon. Accordingly, if a triangle must have a reverse winding order due to sharing edges this way, the computed face normal may be reversed to stay consistent with its neighbors.

When performing ray tracing, the winding order of the polygons is often used to determine the orientation of the faces intersected by the rays. The dot product between the ray direction and the face normal is calculated, and if the result is positive, the face is considered front-facing, indicating that it should be rendered and have shading calculations applied. If the dot product is negative, the face is considered back-facing, and it is typically discarded or treated differently, such as being culled or used for shadow calculations.

For rays, the positive/negative convention is typically reversed from this: a negative dot product means front facing, while a positive means back facing. This is because negative means that the vectors are pointed in opposite directions, i.e., the ray is pointed toward the polygon while the polygon is facing toward the ray origin. When the dot product is positive, the ray is pointed in the same direction as the polygon is facing, and so the ray must be behind it and hitting it from the back.

Properly defining and managing the winding order of polygons ensures accurate visibility determination and consistent rendering results in ray tracing. It helps to correctly identify front-facing and back-facing surfaces, allowing for realistic shading, lighting, and visibility calculations in the rendered scene.

To determine if a ray intersects a convex polygon, an inside/outside test is commonly performed by checking which side of an edge the ray passes. By efficiently sharing edge test results among polygons with shared edges, inside/outside testing for groups of polygons can be made more efficient. This optimization can be achieved using either full-precision floating-point math or reduced precision (e.g., fixed-point math) to make hardware-based testing more cost-effective.

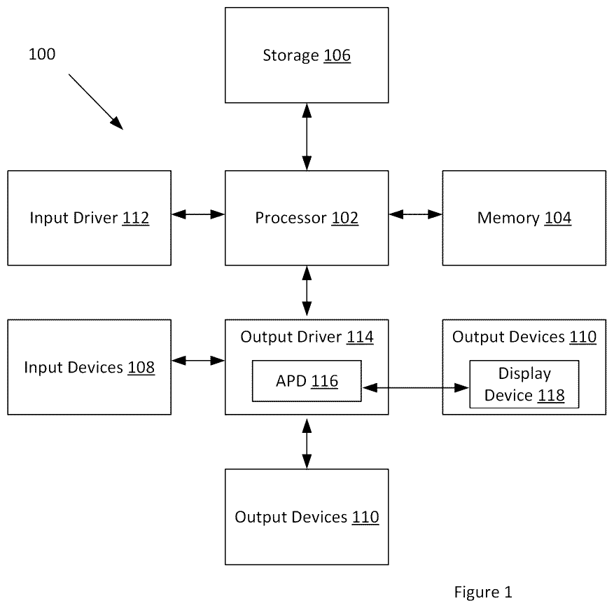

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

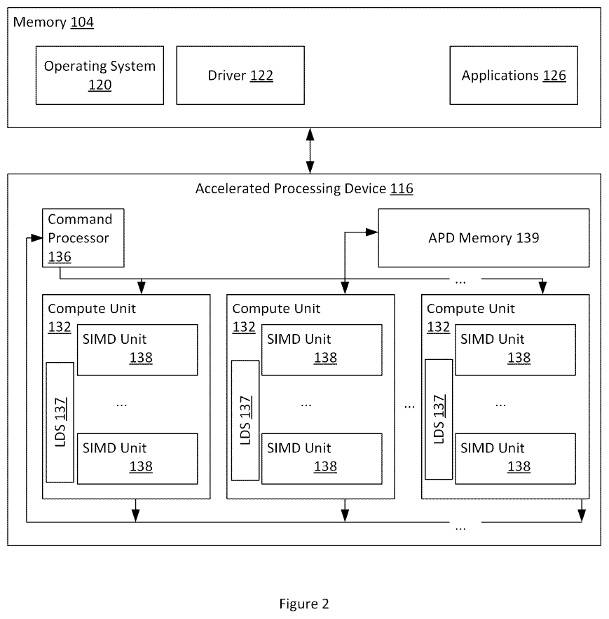

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. The driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The compute units 132 are sometimes referred to as “parallel processing units 202” herein. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

The APD 116 is configured to implement features of the present disclosure by executing a plurality of functions as described in more detail below. For example, the APD 116 is configured to receive images comprising one or more three dimensional (3D) objects, divide images into a plurality of tiles, execute a visibility pass for primitives of an image, divide the image into tiles, execute coarse level tiling for the tiles of the image, divide the tiles into fine tiles and execute fine level tiling of the image. Optionally, the front end geometry processing of a primitive determined to be in a first one of the tiles can be executed concurrently with the visibility pass.

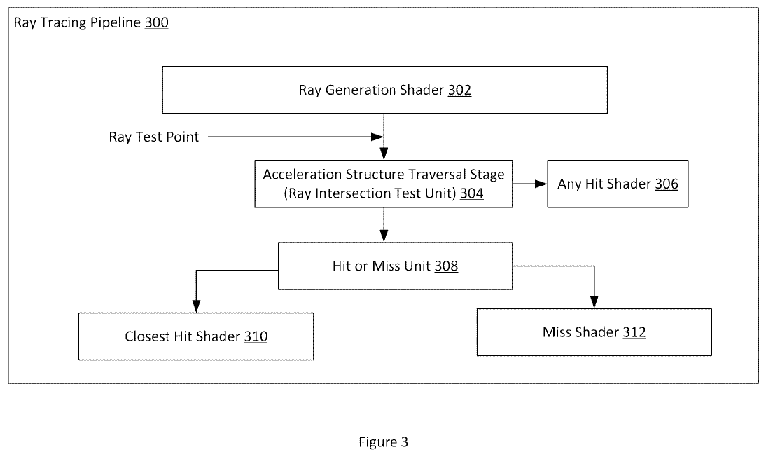

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. In some examples, rendering a scene involves casting at least one ray for each of a plurality of pixels of an image to obtain colors for each pixel.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is. The “ray intersection test” includes an inside/outside test.

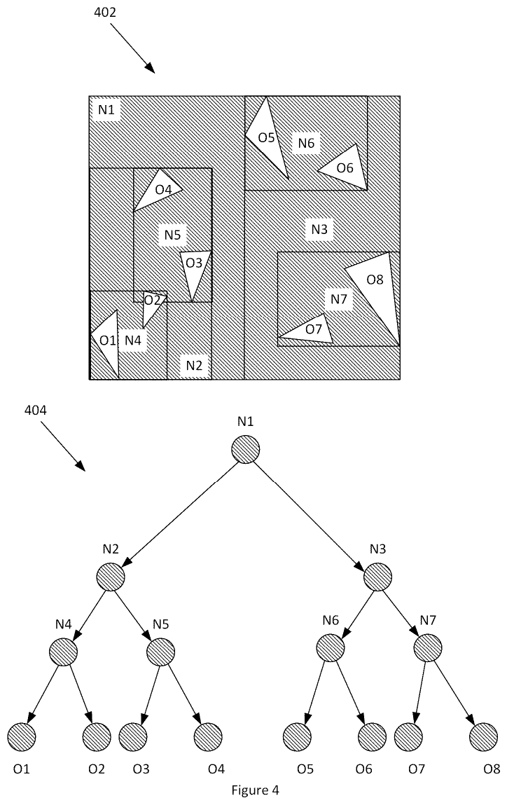

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the top portion of FIG. 4, and the tree representation 404 of the bounding volume hierarchy is illustrated in the bottom portion of FIG. 4. The non-leaf nodes are represented with the letter “N,” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node. Although examples are provided where there is one-triangle-per-leaf, the techniques described are not limited to this situation. For example, a leaf can contain multiple triangles, in which case the ray is tested against all the triangles in the leaf.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that No succeeds, but N₇ fails. The test would test O₅ and O₆, noting that O₅ succeeds, but O₆ fails. Instead of testing eight triangle tests, two triangle tests (O₅ and O₆) and five box tests (N₁, N₂, N₃, N₆, and N₇) are performed.

When checking a ray for intersection with a convex polygon, like a triangle, the inside/outside test examines the ray's orientation in relation to each of the polygon's edges to determine which side it crosses. However, when dealing with groups of convex polygons, such as triangle meshes, quad meshes, triangle strips, triangle fans, and convex polyhedra, independently testing the ray against the edges of each polygon can result in redundant computations, especially when the polygons share edges.

Moreover, when convex polygons share edges but employ different floating-point values during arithmetic computations, discrepancies may arise when rays skim an edge. This discrepancy could result in either double intersections between the two polygons or an erroneous passage between them (e.g., a failure of water tightness).

However, these limitations of inside/outside testing may be overcome by sharing common edge test results between polygons within a mesh.

FIG. 5A illustrates a ray 501 that intersects a first mesh 502. Specifically, FIG. 5A shows that the first mesh 502 is part of a second mesh 500. In many instances, the first mesh 402 is a leaf node from the BVH. The ray 501 is illustrated as a dot because the ray is extending into the page. The dashed lines shown in mesh 500 illustrate the edges of the mesh extended “out to infinity.” For example, the edges may be thought of in the geometric sense as lines and not just line segments.

FIG. 5B illustrates a ray 501 intersecting the first mesh 502. Specifically, FIG. 5B shows that ray 501 intersects triangle 510F. Accordingly, the inside/outside testing for triangle 510F would produce a hit. Similarly, inside/outside testing for triangles 510A, 510B, 510C, 510D, 510E, 510G, 510H, 510I, 510J, and 510K would generate a miss.

FIG. 5C illustrates all of the edges 503a-503u that comprise the mesh 502.

FIG. 5D illustrates the edges 503s-503u that comprise triangle 510F. When inside/outside testing is performed on triangle 510F, ray 501 is compared to each of the edges 503s-503u. For example, in a CCW direction (indicated by the arrowheads), ray 501 is left of edge 503s, left of edge 503u, and left of edge 503t. Since the ray 501 is on the left side of all of the edges, the inside/outside test returns a hit.

Similarly, as shown in FIG. 5E, in a CW direction (indicated by the arrowheads), ray 501 is right of edge 503s, right of edge 503u, and right of edge 503t. Since the ray 501 is on the right side of all of the edges, the inside/outside test returns a hit.

FIG. 5F illustrates the edges 503s, 503i, and 503j that comprise triangle 510E. When inside/outside testing is performed on triangle 510E, ray 501 is compared to each of the edges 503s, 503i, and 503j. For example, in a CW direction (indicated by the arrowheads), ray 501 is left of edge 503s, right of edge 503j, and right of edge 503t. Since the ray 501 is not on the same side of all the edges, the inside/outside test returns a miss.

FIG. 5G illustrates the edges 503u, 503n, and 503o that comprise triangle 510B. When inside/outside testing is performed on triangle 510B, ray 501 is compared to each of the edges 503u, 503n, and 503o. For example, in a CW direction (indicated by the arrowheads), ray 501 is left of edge 503u, right of edge 503o, and right of edge 503n. Since the ray 501 is not on the same side of all the edges, the inside/outside test returns a miss.

FIG. 5H illustrates the edges 503c, 503t, and 503e that comprise triangle 510I. When inside/outside testing is performed on triangle 510I, ray 501 is compared to each of the edges 503c, 503t, and 503e. For example, in a CCW direction (indicated by the arrowheads), ray 501 is left of edge 503c, right of edge 503t, and left of edge 503e. Since the ray 501 is not on the same side of all the edges, the inside/outside test returns a miss.

In inside/outside testing, the process illustrated in FIGS. 5D-5G is repeated for each of the triangles 510A-510 and their respective edges 503a-503u that comprise the mesh 502. Accordingly, in conventional inside/outside testing for the mesh 502, 33 (11 triangles and 3 edges per triangle) edge-to-ray comparisons would need to be performed.

However, mesh 502 only contains only 21 unique edges (edges 503a-503u). Accordingly, the conventional inside/out testing performs 12 duplicate calculations. For example, as shown in FIG. 5D and FIG. 5F, edge 503s would need to be compared to the ray 501 for both triangles 510F and 510E. Similarly, as shown in FIG. 5D and FIG. 5G, edge 503u would need to be compared to the ray 501 for both triangles 510F and 510B. Likewise, FIG. 5D and FIG. 5H show that edge 503t would need to be compared to ray 501 for both triangle 510F and 510I.

As illustrated by FIG. 5H, even when the direction is reversed, there is still a deduplication of calculations. Reversing the direction of an edge simply means that the left/right determination for the ray is swapped. For example, edge 503t is shared between triangles 510F and 510I, but with reversed direction. If the algorithm has already calculated that the ray is to the left of edge 503t for triangle 510F (as in FIG. 5D), then the algorithm knows that it must to the right of edge 503t for triangle 510I (as in FIG. 5H). Accordingly, the algorithm does not need to recompute it. Instead, the algorithm simply swaps the prior result between left and right.

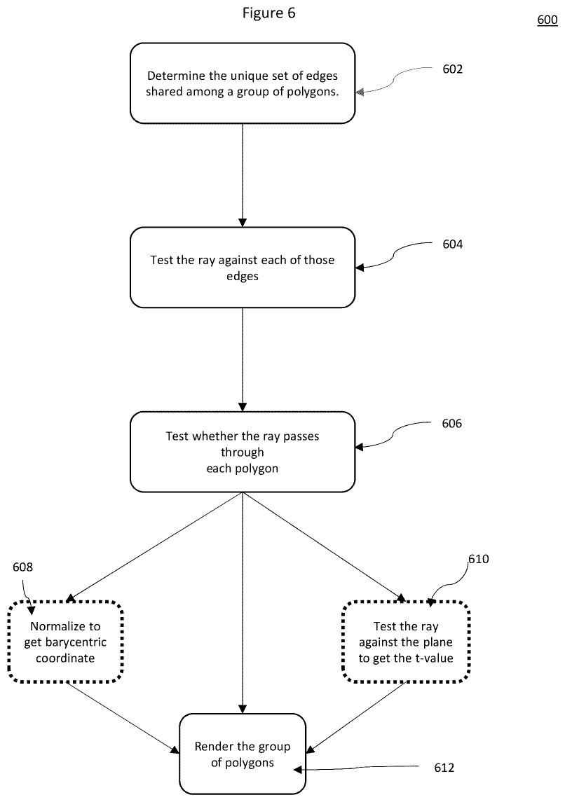

FIG. 6 is a flow diagram of a method 600 for performing Inside/outside testing according to an example. In some instances, the method 600 can save nearly half the number of edge tests compared to testing each polygon independently for a typical manifold surface.

In some instances, the method 600 can be used with predefined small polyhedral topologies (e.g., k-dops) for bounding volumes during traversal. In other instances, the method 600 is performed on the leaf nodes in the BVH.

In step 602, the unique set of edges shared among a group of polygons that comprise a mesh (e.g., mesh 502) is determined. In some instances, the unique set of edges are determined by implementing an algorithm that visits each edge of each triangle. In these situations, the algorithm takes the two vertices that define each edge and checks against the set of unique edges to determine if an edge with those vertices is already included in the set. If not already in the set, then the algorithm adds the edge to the set of unique edges. Otherwise, it is a duplicate. Many programming languages have datatypes for sets that enforce uniqueness and discard duplicates automatically.

In some situations, there may already be a corresponding edge in the set but with the starting and ending vertices swapped (according to the winding order of the current triangle). In that case, the algorithm would still consider this a duplicate edge, but the record for this triangle needs to reverse the left/right result from the edge test when using it (i.e., a result of “right” for that edge would be treated as “left” for this triangle and v.v.). In some instances, checking to see if an edge is already in the list could just be a simple linear scan over the existing edges in the set. Or it could be a hash set or a tree set to make checking for existing edges faster.

In some instances, the unique set of edges that comprise the mesh may be determined by implementing an algorithm that makes a list of all edges without worrying about duplicates with the start and end vertices ordered in some fashion (e.g., by vertex index) and the triangle reversal noted. For example, an edge from vertices 10 to 7. The algorithm then records that as an edge from 7 to 10, since 7<10, but reversed for this triangle. Then, sort the list of edges by some criteria, such as lexicographically. This brings all of the duplicate edges together into blocks within the list, and a single linear pass can filter out the duplicates that repeat the edge before it.

In some instances, the unique edges are determined as part of the BVH building process. Accordingly, in many situations, the list of unique edges are stored as part of the leaf node data. Or for the predefined polyhedral topologies stored as part of their definitions. In some instances, the BVH builder can pre-determine the configuration of the unique set of edges to test.

Then, in step 604, each of the edges determined in step 602 are compared with a ray (e.g., ray 501), and the results are stored in the working memory. In some instances, all of the edges (e.g., edges 503a-503u) are tested against the ray (e.g., ray 501) concurrently.

In some instances, the comparison with each respective edge is performed using reduced-precision math with a variation on the conservative rasterization adjustment described in “Reduced Precision Ray-Triangle Intersection Filtering” by Keely and Fussell which is hereby incorporated by reference in its entirety. In many instances, the Method 600 is able to improve, and in many instances, maintain water tightness for the mesh even when reduced precision fixed-point and/or reduced floating point precision math is utilized because the same result of the comparison is utilized for shapes that share a common edge within the mesh. As a result, even if the mathematical result is in error as compared with a calculation using infinite precision, and thus, the “wrong” triangle is determined to be intersected, the important aspect is that the answer is consistent since this prevents the water tightness gap.

Then in step 606, for each triangle (e.g., triangles 510A-510k) that comprises the mesh (e.g., mesh 502), compare the test results generated in step 604 for its subset of edges (e.g, edges 503s, 503t, and 503u for triangle 510f) to determine if the ray passed all on same side. If the ray passes on the same side, the method 600 generates a hit. Otherwise, method 600 generates a miss for the inside/outside test. In determining which side the ray passes on, in some instances the winding direction of the utilized in step 604 and the winding direction of the respective shape in the mesh must be accounted for.

For example, after deduplication of the edges, triangle 510f may be recorded as having edges: 503s (forward); 503t (forward); and 503u (reversed). Then in step 606 the edge test results for s, t, and u would be calculated. However, the result of u would need to be flipped when checking to see if they are all the same.

For example, if the original edge tests for the ray said: s=left, t=left, u=right. Then, after reversing u, a hit is generated because of left/left/left.

In some situations, it is possible for all three edges of a triangle to be recorded as reversed. For example, in the case of two-sided triangles, there is no difference compared to recording them as all-forward. But it can make a difference when the triangles are single-sided and only accept hits that hit the front side. In those cases, left/left/left may only be accepted, and right/right/right rejected as a miss. In some situations, the orientation of the triangles can then be included in the expected orientations of the edges.

Optionally, in step 608, if the ray passes through the polygon (e.g., triangle 410F), the values from the edge tests may be normalized to get barycentric coordinates.

Optionally, in step 610, if the ray passes through the polygon (e.g., triangle 410F), the ray may be tested against the plane that contains the polygon to get the distance from the ray origin to the intersection point on the plane (t-value).

This approach can significantly reduce the number of edge tests needed for typical manifold surfaces, saving almost half compared to testing each polygon independently. By sharing a single edge test between adjacent polygons, the chances of double intersections or rays passing between polygons are minimized. Unless intersecting at an oblique angle, a ray passing through the interior of one polygon will be outside its neighboring polygon, and vice versa.

In step 612, one or more polygons of the group of polygons are rendered using a graphics pipeline based on the testing results determined in step 606. In some instances, the rendering includes performing a watertightness check that excludes checking the watertightness of polygons that share common edges.

When combined with reduced-precision arithmetic, this technique allows for the efficient determination of definite misses and/or hits within the group of polygons. This can be particularly useful for certain applications, such as intersections with bounding volumes during BVH traversal, where this alone may suffice. For applications requiring full precision, it can still help reduce the number of full-precision intersection tests required.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the compute units 132, the SIMD units 138, the ray tracing pipeline 300, including the ray generation shader 302, the ray intersection test unit 304, the any hit shader 306, the hit or miss unit 308, the closest hit shader 310, or the miss shader 312, be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for improving performance of a graphics processing pipeline, the method comprising:
determining a unique set of edges that are shared among a group of polygons;
testing a ray against each of the unique set of the edges that are shared among the group of the polygons, wherein the testing generates a result for each edge included in the unique set of the edges;
determining a polygon among the group of the polygons that is intersected by the ray based on the result for each respective edge that comprises the polygon; and
rendering the polygon.

2. The method of claim 1, wherein the group of the polygons is a leaf node of a bounding volume hierarchy (BVH).

3. The method of claim 1, wherein the testing is performed concurrently on the unique set of the edges.

4. The method of claim 1, wherein the testing is performed using reduced precision operations.

5. The method of claim 1, wherein the rendering includes excluding particular edges that are shared among adjacent polygons among the group of the polygons from watertightness testing.

6. The method of claim 1, the result for each edge included in the unique set of the edges includes a winding order.

7. The method of claim 1, wherein the result for each edge included in the unique set of the edges includes a face normal.

8. A system for improving performance of a graphics processing pipeline, the system comprising:
a memory; and
one or more processors that are communicatively coupled to the memory, wherein the one or more processors are collectively configured to:
determine a unique set of edges that are shared among a group of polygons,
test a ray against each of the unique set of the edges that are shared among the group of the polygons to generate a result for each edge included in the unique set of the edges,
determine a polygon among the group of the polygons that is intersected by the ray based on the result for each respective edge that comprises the polygon; and
render the polygon.

9. The system of claim 8, wherein the group of the polygons is a leaf node of a bounding volume hierarchy (BVH).

10. The system of claim 8, wherein the unique set of the edges are tested concurrently.

11. The system of 8, wherein the unique set of the edges are tested using reduced precision operations.

12. The system of claim 8, wherein the polygon is rendered by excluding particular edges that are shared among adjacent polygons among the group of the polygons from watertightness testing.

13. The system of claim 8, the result for each edge included in the unique set of the edges includes a winding order.

14. The system of claim 8, wherein the result for each edge included in the unique set of the edges includes a face normal.

15. A non-transitory computer readable storage medium storing instructions for improving performance of a graphics processing pipeline, the instructions when executed by one or more processors cause the one or more processors to collectively execute a method comprising:
determining a unique set of edges that are shared among a group of polygons;
testing a ray against each of the unique set of the edges that are shared among the group of the polygons, wherein the testing generates a result for each edge included in the unique set of the edges;
determining a polygon among the group of the polygons that is intersected by the ray based on the result for each respective edge that comprises the polygon; and
rendering the polygon.

16. The non-transitory computer readable storage medium of claim 15, wherein the group of the polygons is a leaf node of a bounding volume hierarchy (BVH).

17. The non-transitory computer readable storage medium of claim 15, wherein the testing is performed concurrently on the unique set of the edges.

18. The non-transitory computer readable storage medium of claim 15, wherein the testing is performed using reduced precision operations.

19. The non-transitory computer readable storage medium of claim 15, wherein the rendering includes excluding particular edges that are shared among adjacent polygons among the group of the polygons from watertightness testing.

20. The non-transitory computer readable storage medium of claim 15, the result for each edge included in the unique set of the edges includes a winding order.
